(19) United States
(12) Patent Application Publication
(10) Pub. No.: US 2026/0256547 A1
(43) Pub. Date: Sep. 3, 2026

(54) CLEAR ORTHODONTIC ALIGNER

(71) Applicant: FONDAZIONE IRCCS "CA' GRANDA - OSPEDALE MAGGIORE POLICLINICO", Milano (IT)

(72) Inventors: Gianluca Tartaglia, Rodano (Milano) (IT); Irini Gerges, Sesto San Giovanni (Milano) (IT); Alberto Caprioglio, Pavia (IT); Aldo Bruno Gianni', Basiglio (Milano) (IT); Riccardo Goldoni, Pianoro (Bologna) (IT); Andrea Mapelli, Castelnovo (Lecco) (IT)

(73) Assignee: FONDAZIONE IRCCS "CA' GRANDA - OSPEDALE MAGGIORE POLICLINICO", Milano (IT)

(21) Appl. No.: 18/993,764

(22) PCT Filed: Jul. 12, 2023
(86) PCT No.: PCT/IB2023/057143

§ 371 Date: Jan. 13, 2025

(30) Foreign Application Priority Data
Jul. 13, 2022 (IT) 102022000014740

(51) Int. Cl. A61C 7/08; B33Y 10/00

(52) U.S. Cl. CPC A61C 7/08; A61C 2201/002; B33Y 10/00

(57) ABSTRACT

The present invention relates to a clear orthodontic aligner comprising at least one molecule capable of changing color or color intensity (CCM). Furthermore, the invention relates to a process for obtaining a clear orthodontic aligner by means of three-dimensional (3D) printing.

### FIELD OF THE INVENTION

The present invention relates to a clear orthodontic aligner and a method for obtaining the clear orthodontic aligner.

### STATE OF THE ART

Dental malocclusion is a condition in which the dental elements of the upper arch are not perfectly aligned with the teeth of the lower arch. In other words, dental malocclusion means an anomalous relationship between the teeth of the maxilla and those of the mandible.

In normal health conditions, the dental arches are in a perfect, balanced relationship, such as to adequately enable chewing and swallowing. Dental malocclusion, by contrast, manifests itself when this perfect relationship between the two arches is not present. In these conditions, the imperfect occlusion of the dental arches can also cause problems in parts of the body. For example, in addition to chewing and phonetic disorders, malocclusion can bring about an increase in the risk of neck pain, backache, incorrect posture, headaches and tinnitus (buzzing in the ears).

Clear orthodontic aligners are among the most widely used treatments to reduce or resolve the problem of malocclusion. Said aligners are “masks”, that is, plastic dental appliances that are made to measure for each patient and adapt perfectly to teeth. Thanks to the forces that are applied by the aligners on teeth, a movement of the teeth themselves is obtained until a perfect occlusion of the teeth is reached. Real-time detection of orthodontic movement during application of an aligner can significantly improve the standard of care by enabling adjustment of the orthodontic therapeutic treatment based on the application of orthodontic force according to patient response.

Various aligners capable of monitoring orthodontic movements are described in the literature; for example, WO2015176004 describes the used of chips integrated into a dental crown to monitor orthodontic activity over a long period.

The integration of sensors in devices that can be worn in the oral cavity is also disclosed in WO2015112638A1, which describes an electrochemical sensor connected to a device wearable on teeth.

U.S. Pat. No. 10,639,134B2 describes an orthodontic appliance comprising biosensors capable of interacting with salivary biomarkers and transducing said interaction into an electric signal.

The aligners described in the literature, despite allowing the monitoring of orthodontic movement, are of complex construction and comprise sensors whose cost is high. Considering that clear orthodontic aligners are devices that are replaced every 1-2 weeks, to enable a correct orthodontic movement, it is necessary for them to have a relatively low cost. Furthermore, throughout the whole duration of the treatment, the patient must go to a dentist or a specialist at least once a month to check the orthodontic movement. The aligners present on the market or described in the literature do not allow a direct detection of orthodontic movement, or the detection takes place using complex interfaces or equipment, such as, for example, software for analyzing the data read by the chips or electro-sensors.

Therefore, there is a need to obtain a clear orthodontic aligner that enables real-time monitoring of orthodontic movement and has low production costs.

### BRIEF DESCRIPTION OF THE FIGURES

FIGS. 1 and 2 show clear 3D printed orthodontic aligners, wherein the CCMs are incorporated in the blind spots of said clear orthodontic aligners; and

FIG. 3 shows A) a clear 3D printed orthodontic aligner characterized by a customizable porosity and B) a high-magnitude image that shows the interconnected structure of the pores of the 3D printed orthodontic aligner.

### SUMMARY OF THE INVENTION

A first aspect of the present invention relates to a clear orthodontic aligner. Said orthodontic aligner comprises at least one molecule capable of changing color or color intensity (CCM) as a result of an interaction between said at least one CCM and at least one enzyme or salivary biomarker.

La reaction between said at least one CCM and the at least one enzyme or salivary biomarker results in colorimetric or visual changes of the at least one CCM which are detected with the naked eye by the professional, for example, by the dentist, and/or by the patient.

In one embodiment of the invention, the at least one CCM is positioned in at least one blind zone or blind spot of the clear orthodontic aligner. In this manner, the aesthetic aspect of the clear orthodontic aligner is maintained, since the at least one CCM, and thus its color and the variations in its color, are not visible from outside the mouth when the aligner is worn by the individual.

A second aspect of the present invention relates to a process for obtaining a clear orthodontic aligner. Said process preferably comprises the steps of:
a) preparing a first composition comprising at least one molecule capable of changing color and/or color intensity (CCM) as a result of an interaction with at least one enzyme or salivary biomarker expressed during a phase of bone remodeling following the orthodontic movement of the teeth and/or bone absorption,
b) polymerizing the first composition, and
c) printing the first composition using a three-dimensional (3D) printer.

A third aspect of the present invention relates to a method for the treatment and/or prevention of an orthodontic pathology or condition. Preferably, said orthodontic pathology or condition is an orthodontic malocclusion.

### Definitions

In the context of the present invention, the expression “gingival crevicular fluid” means an exudate consisting of altered serum, which is found in the gingival sulcus. Irritations and inflammations of gingival tissues increase the flow and alter the constituents of crevicular fluid.

In the context of the present invention, the expression “blind zone” or “blind spot” means a zone of a clear orthodontic aligner that is visible when the orthodontic aligner is not positioned in the individual's mouth, i.e. when it is outside the individual's mouth, or during a very wide opening of the mouth. In other words, the blind zone or the blind spot is not visible during the normal activities of the mouth, such as, for example, while the individual is having a meal or laughing.

### DETAILED DESCRIPTION OF THE INVENTION

A first aspect of the present invention relates to a clear orthodontic aligner. Said orthodontic aligner comprises at least one molecule capable of changing color or color intensity (CCM) as a result of an interaction between said at least one CCM and at least one enzyme or salivary biomarker. Preferably, said at least one enzyme or biomarker is expressed during a phase of bone remodeling following orthodontic movement of the teeth and/or bone absorption. In other words, said at least one CCM is a molecule that changes color or color intensity when it interacts with at least one enzyme or biomarker present in an individual's saliva. Said at least one enzyme or salivary biomarker is preferably expressed during orthodontic bone remodeling due to movement of the teeth and/or bone absorption. The interaction between the at least one CCM and the at least one enzyme or salivary biomarker causes a chemical reaction that leads to the change in the color or color intensity of the at least one CCM. The reaction of said at least one CCM with the at least one enzyme or salivary biomarker results in a change in the color or color intensity of the at least one CCM which is detected with the naked eye by the professional, for example by the dentist, and/or by the patient. In one embodiment, said change in the color or color intensity of the at least one CCM is detected with techniques and/or instruments known to the person skilled in the art. Preferably, the at least one CCM is capable of qualitatively detecting the presence of at least one enzyme or salivary biomarker present in the saliva and/or gingival crevicular fluid. Said at least one enzyme or biomarker is, for example, a pro-inflammatory mediator, an anti-inflammatory mediator, a bone enzyme, or a bone marker.

In one embodiment, the at least one enzyme or salivary biomarker is selected from: tartrate-resistant acid phosphatase (TRAP), f alkaline phosphatase (ALP), lactate dehydrogenase (LDH), aspartate aminotransferase (AST) and a combination thereof.

In one embodiment of the invention, the at least one CCM is for example p-nitrophenylphosphatase (p-NPP).

In one embodiment of the invention, the at least one CCM is positioned in at least one blind zone or blind spot of the clear orthodontic aligner. In other words, the at least one CCM is visible to the health professional, for example the dentist, during an orthodontic treatment or when the aligner is not positioned in the individual's mouth. In this manner, the aesthetic appearance of the clear orthodontic aligner is maintained, as the at least one CCM, and thus its color and the variations in its color, are not visible from outside the mouth when the aligner is worn by the individual. In one embodiment, the orthodontic aligner of the present invention comprises or consists of a porous structure which enables the penetration of saliva and/or gingival crevicular liquid into the structure of the aligner itself. In fact, as the at least one CCM is incorporated into the orthodontic aligner, the penetration by saliva and crevicular fluid into the structure of the aligner through the pores enables a better interaction between the at least one CCM and the at least one enzyme or salivary biomarker and a more effective detection of the presence of the at least one enzyme or biomarker. In other words, the orthodontic aligner has a structure or a matrix that comprises a plurality of pores and voids adapted to allow the penetration of saliva and/or crevicular fluid. The diffusion of saliva and/or crevicular fluid through the pores of the matrix of the aligner takes place spontaneously thanks to the frequent collapsing and de-collapsing of the pores due to the compression of the matrix during the biting and chewing that take place during the individual's daily routine.

In one embodiment, the average diameter of the pores and voids is between 0.02 mm and 0.2 mm, preferably between 0.05 mm and 0.15 mm.

In one embodiment, the pores and voids are interconnected, with a percentage of interconnectivity of the pores between 30% and 100%, more preferably between 60% and 100%. Preferably, said percentage of interconnectivity is calculated according to the following formula: interconnectivity %=(number of pores connected to each other/total number of pores)×100.

In one embodiment, the aligner comprises at least one polymer, preferably selected from: acrylate, methacrylate, n-butyl acrylate, acrylamide, methacrylamide, n-butyl acrylamide, styrene derivatives preferably selected from: p-methoxystyrene (pMOS), p-hydroxystyrene (p-HS), p-tert-butyloxystyrene (t-BOS), p-methylstyrene (p-MSt), diphenylethylene (DPE), 2,4,6-trimethylstyrene (TMSt), 6-t-butoxy-2-vinylnaphthalene (tBOVN), α-derivative of methyl styrene, isobutylene derivative and combinations thereof. In a preferred embodiment, the polymer is methacrylate.

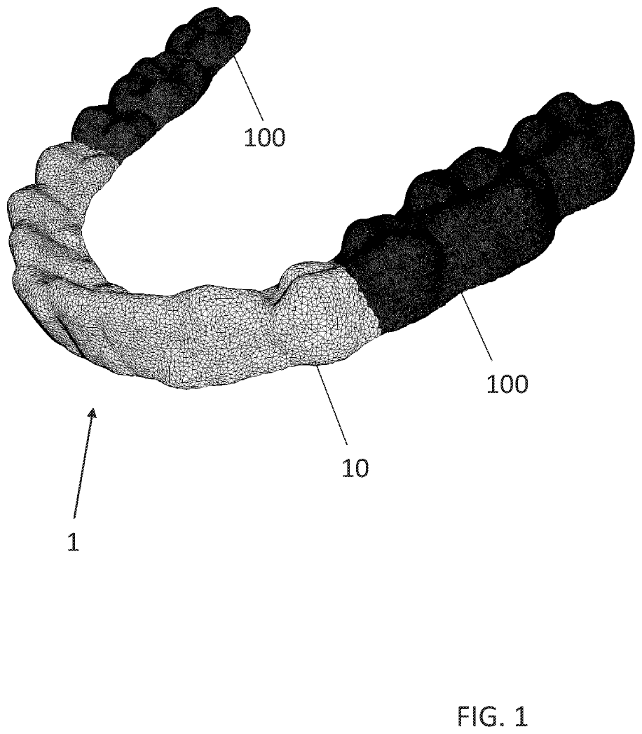

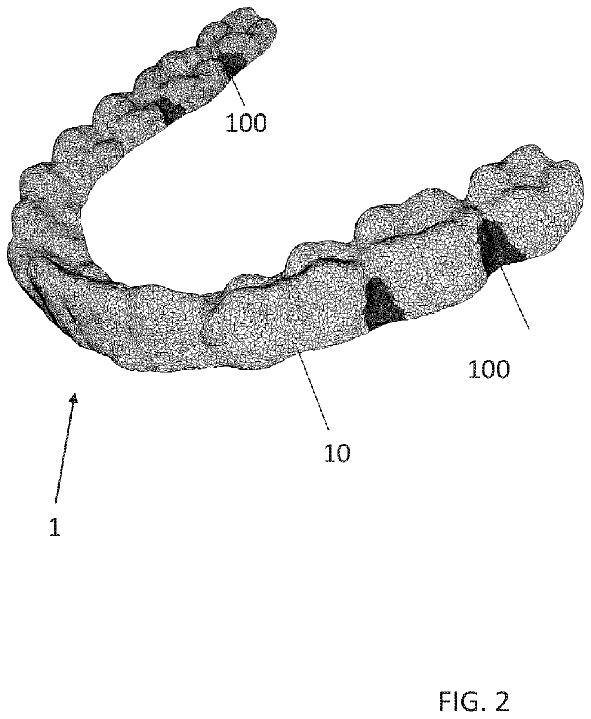

With reference to FIGS. 1 and 2, the orthodontic aligner 1 of the present invention comprises a structure 10 that is preferably porous, as described above. Said structure 10 preferably comprises at least one blind zone or blind spot 100 where at least one CCM is positioned or incorporated as described above.

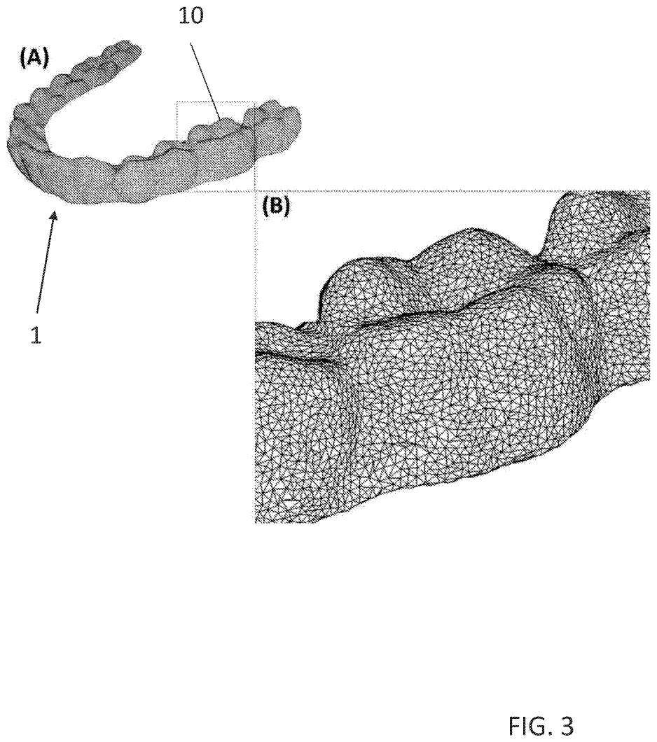

In fact, with reference to FIG. 3A, the orthodontic aligner 1 comprises a structure 10 that is preferably porous, as illustrated in FIG. 3B.

In one embodiment, the aligner is obtained thanks to a 3D printing process and photo-crosslinking of at least one composition comprising the at least one CCM. Preferably, the aligner is obtained thanks to the process described in detail below.

The Applicant has obtained a clear orthodontic aligner which enables real-time detection of at least one enzyme or salivary biomarker expressed during a process of orthodontic movement. The use of said orthodontic aligner can significantly improve the standard of care for orthodontic pathologies, such as, for example, dental malocclusions, thereby enabling a precise regulation of the therapeutic orthodontic treatment, based on the application of orthodontic force according to the patient's response, i.e. the expression of at least one enzyme or salivary biomarker. The enzymes and biomarkers are present in the patient's saliva and crevicular liquid and vary according to the phase of bone remodeling. During the phase of activating the orthodontic movement of the teeth, osteoblasts and osteoblast progenitors are recruited, with the simultaneous expression of the biomarkers.

The orthodontic aligner of the present invention makes it possible to improve the quality of life of individuals with orthodontic pathologies by reducing the duration of the treatment and the costs thereof.

A second aspect of the present invention relates to a process for obtaining a clear orthodontic aligner. Preferably, said process comprises the following steps:
a) preparing a first composition comprising at least one molecule capable of changing color and/or color intensity (CCM) as a result of an interaction between said at least one CCM and at least one enzyme or salivary biomarker expressed during a phase of bone remodeling following orthodontic movement and/or bone absorption,
b) polymerizing the first composition, and
c) printing the first composition using a 3D printer.

In one embodiment, the process further comprises the following sub-steps:
a1) preparing a second composition comprising a polymeric precursor,
b1) polymerizing the second composition, and
c1) printing the second composition using a 3D printer.

In one embodiment, the at least one polymeric precursor is selected from acrylate, methacrylate, n-butyl acrylate, acrylamide, methacrylamide, n-butyl acrylamide, isobutylene derivative, styrene derivatives preferably selected from: p-methoxystyrene (pMOS), p-hydroxystyrene (p-HS), p-tert-butyloxystyrene (t-BOS), p-methylstyrene (p-MSt), diphenylethylene (DPE), 2,4,6-trimethylstyrene (TMSt), 6-t-butoxy-2-vinylnaphthalene (tBOVN), α-derivative of methyl styrene, and combinations thereof.

In one embodiment of the invention, the at least one CCM is for example p-nitrophenylphosphatase (p-NPP).

In one embodiment, the first and second compositions are preferably liquid solutions or suspensions, more preferably oil suspensions in water or in another solvent.

In one embodiment, the dispensing or printing of the first composition during step c) takes place during printing of a blind zone or blind spot of the clear orthodontic aligner. In other words, the first composition comprising the at least one CCM is dispensed by the 3D printer only during the printing of a blind zone or blind spot of the orthodontic aligner, so that the at least one CCM is positioned and incorporated in the orthodontic aligner in at least one blind zone or blind spot.

In one embodiment, the first composition comprises the polymeric precursor. Preferably, the first and second compositions are introduced into the 3D printer in two separate, non-communicating reservoirs.

In one embodiment, the 3D printer comprises a plurality of reservoirs.

Preferably, said reservoirs comprise a plurality of compositions comprising at least one CCM and a plurality of compositions comprising a polymeric precursor.

In a preferred embodiment of the invention, the first and second compositions are mixed together prior to the polymerization steps b) and b1); the mixing of the first and second compositions preferably takes place in at least one printing nozzle of the 3D printer or before they reach at least one printing nozzle.

The above-described process is preferably controlled and regulated by software of the 3D printer. In one embodiment, said software is CAD/CAM software of the 3D printer.

In one embodiment, the polymerization steps b) and b1) take place in at least one printing nozzle of the 3D printer.

Preferably, the polymerization of the first and second compositions takes place by photo-crosslinking, more preferably with a UV source, even more preferably with a UV source at a wavelength of between 315 and 450 nm.

Said UV light source is selected from: laser stereolithography (SLA), digital light projection (DLP) and liquid crystal display (LCD). In a preferred embodiment, the photo-crosslinking takes place by means of SLA.

In one embodiment, the process further comprises a step of collecting the individual's anatomical data and a step of designing the clear orthodontic aligner. Preferably, said data collection and design steps are carried out prior to step a).

In one embodiment, the individual's anatomical data are collected with techniques known to the person skilled in the art, preferably thanks to an intraoral scanner. Preferably, the design of the clear orthodontic aligner is produced using CAD/CAM software, more preferably CAD/CAM software of the 3D printer.

A third aspect of the present invention relates to a method for the treatment and/or prevention of an orthodontic pathology or condition.

Preferably, said orthodontic pathology or condition is a malocclusion.

In one embodiment, said method comprises at least one step of applying a clear orthodontic aligner as described above in detail on an individual who has a need therefor. Preferably, the method comprises a step of detecting a change in the color or color intensity of the at least one CCM of the clear orthodontic aligner.

In one embodiment, the change in the color or color intensity of the at least one CCM is indicative of an orthodontic movement.

Preferably, the change in the color or color intensity of the at least one CCM is detected with the naked eye by the professional, for example the dentist, and/or by the patient. In one embodiment, said colorimetric change of the at least one CCM is detected with techniques and/or instruments known to the person skilled in the art.

### EXAMPLES

### Example 1

The patient's anatomical data were collected using an intraoral scanner and the structure of the clear orthodontic aligner was defined by means of CAD software. The clear orthodontic aligner was directly 3D printed by photo-crosslinking of a dimethacrylate-based polymeric precursor using a 3D printer equipped with an SLA (laser stereolithography) UV light source operating at 51.2 mJ/cm². The photo-crosslinking took place at room temperature (from 20° C. to 30° C.) at a wavelength of 405 nm.

Microparticles of para-nitrophenylphosphatase (p-NPP) were prepared with the oil/water/oil method to protect the p-NPP against exposure to light.

In the blind spots of the aligner, the microparticles containing the CCM, or para-nitrophenylphosphatase (p-NPP), were suspended in the dimethacrylate-based polymeric precursor at a concentration of 0.1 g/mL; then the 3D printing process proceeded to permanently trap the microparticles containing p-NPP within the photo-crosslinked transparent resin of the clear aligner.

The aligner matrix was characterized by a porous structure in which the distance between the interconnected polymeric filaments, i.e. the pore size, was 0.05 mm.

### Example 2

The orthodontic aligner obtained in Example 1 was mechanically characterized according to standard ASTM D638 for the determination of the tensile properties of plastic materials. The flexural modulus and strength were determined according to ISO 20795-2 guidelines (Table 1).

TABLE 1
Mechanical properties of the 3D printed clear aligner
obtained according to the procedure in example 1.

| Parameter | Value | |
|---|---|---|
| Tensile modulus of elasticity | 2200 | MPa |
| Tensile strength | 74 | MPa |
| Flexural modulus | 1600 | MPa |
| Flexural strength | 80 | MPa |

1. A clear orthodontic aligner comprising at least one molecule capable of changing color and/or color intensity (CCM), wherein said at least one molecule is capable of changing color and/or color intensity as a result of an interaction with at least one enzyme or salivary biomarker expressed during a phase of bone remodeling following orthodontic movement and/or bone absorption.

2. The clear orthodontic aligner according to claim 1, wherein the at least one enzyme or salivary biomarker is selected from: tartrate-resistant acid phosphatase (TRAP), alkaline phosphatase (ALP), lactate dehydrogenase (LDH), aspartate aminotransferase (AST) and a combination thereof.

3. The clear orthodontic aligner according to claim 1, wherein the at least one CCM is positioned in a blind zone or blind spot of the clear orthodontic aligner.

4. The clear orthodontic aligner according to claim 1, comprising at least one polymer selected from: acrylate, methacrylate, n-butyl acrylate, acrylamide, methacrylamide, n-butyl acrylamide, isobutylene derivative, styrene derivatives, α-derivative of methyl styrene, and combinations thereof.

5. The clear orthodontic aligner according to claim 1, characterized by an interconnected porous structure with a pore size between 0.02 mm and 0.2 mm, more preferably between 0.05 mm and 0.15 mm.

6. The clear orthodontic aligner according to claim 5, wherein the percentage of interconnectivity of the pores is between 30% and 100%, wherein said interconnectivity % is calculated according to the following formula: interconnectivity %=(number of pores connected to each other/total number of pores)×100.

7. A process for obtaining a clear orthodontic aligner, comprising the steps of:
a) preparing a first composition comprising at least one polymeric precursor and at least one molecule capable of changing color and/or color intensity (CCM) as a result of an interaction with at least one enzyme or salivary biomarker expressed during a phase of bone remodeling following orthodontic tooth movement and/or bone absorption,
b) polymerizing the first composition, and
c) printing the first composition using a three-dimensional (3D) printer.

8. The process according to claim 7, wherein the printing of the first composition, during step c), occurs while printing a blind zone or blind spot of the clear aligner.

9. The process according to claim 7, comprising the following sub-steps:
a1) Preparing a second composition comprising a polymeric precursor,
b1) polymerizing the second composition, and
c1) printing the second composition using a 3D printer.

10. The process according to claim 9, wherein the at least one polymeric precursor is selected from:
acrylate, methacrylate, n-butyl acrylate, acrylamide, methacrylamide, n-butyl acrylamide, isobutylene derivative, styrene derivatives, α-derivative of methyl styrene, and combinations thereof.

11. The clear orthodontic aligner according to claim 5, wherein the interconnected porous structure has a pore size between 0.05 mm and 0.15 mm.

12. The clear orthodontic aligner according to claim 6, wherein the percentage of interconnectivity of the pores is between 60% and 100%.

13. The clear orthodontic aligner according to claim 4, wherein the styrene derivative is selected from: p-methoxystyrene (pMOS), p-hydroxystyrene (p-HS), p-tert-butyloxystyrene (t-BOS), p-methylstyrene (p-MSt), diphenylethylene (DPE), 2,4,6-trimethylstyrene (TMSt) and 6-t-butoxy-2-vinylnaphthalene (tBOVN).

14. The process according to claim 10, wherein the styrene derivative is selected from: p-methoxystyrene (pMOS), p-hydroxystyrene (p-HS), p-tert-butyloxystyrene (t-BOS), p-methylstyrene (p-MSt), diphenylethylene (DPE), 2,4,6-trimethylstyrene (TMSt) and 6-t-butoxy-2-vinylnaphthalene (tBOVN).
